(19) United States
(12) Patent Application Publication
(10) Pub. No.: US 2012/0231149 A1
(43) Pub. Date: Sep. 13, 2012

(54) Method for Treating Honey in Order to Obtain a Clear Liquid Honey

(76) Inventor: Benjamin Poirot, Champagne Les Marais (FR)

(21) Appl. No.: 13/496,010

(22) PCT Filed: Sep. 14, 2010
(86) PCT No.: PCT/FR2010/000620

§ 371 Date: May 29, 2012

(30) Foreign Application Priority Data
Sep. 14, 2009 (EP) 09290700.5

(51) Int. Cl. A23L 1/08; A23L 1/015

(52) U.S. Cl. 426/658; 426/495

(57) ABSTRACT

The present invention relates to a method for treating honey which is at least partially crystallized, with a view to obtaining a honey which can be stored for several months at ambient temperature while remaining liquid and transparent. The method is based on the separation and extraction of at least a part of the glucose crystals present in the honey. This extraction can be carried out by centrifugation or by ultrafiltration. This method excludes heating the honey at a high temperature for a long period of time, and therefore makes it possible to preserve all the properties thereof.

The present invention relates to a method for treating at least partially crystallized honey in order to obtain honey which can be stored for several months at ambient temperature while remaining liquid and transparent. The method is based on the separation and extraction of at least part of the glucose crystals present in honey.

Honey is composed of:
sugars, which represent about 80% of honey: the sugars most widely represented are glucose and fructose, but honey also contains maltose, sucrose, trisaccharides and higher sugars
water (17 to 20%)
various substances (about 3%) including organic and amino acids, inorganic salts, volatile materials which give honey its flavor, pigments which give it its color, vitamins: B1, B2, PP . . . , enzymes and the like.

The word “honey” generally denotes honey from nectar (or honey from flowers), produced by bees as their food. Bees also use another source of additional supply, or of replacement: honeydew. Honeydew is a sticky and sweet colorless liquid. It is the final product of the digestion of tree sap by aphids which are present on conifers such as pine, fir, spruce and larch or on broadleaf trees such as oak, lime, chestnut, poplar, willow, maple and the like. This viscous or crystallized honeydew is then licked up by the honey-gathering insects on the leaves. All honeydew honeys have a dark reddish color. In the present text, the word “honey” is used to denote both nectar honey and honeydew honey.

At the time of harvest, all honeys are liquid. Depending on their glucose content, they harden and crystallize more or less rapidly. Their origin, and in particular the flowers from which honey is gathered by bees, give them their characteristics.

The crystallization process is unavoidable and is due to the supersaturation of honey with sugar. The first sugar crystals formed are composed of glucose since it is the least soluble sugar present in honey.

Honey is 70% marketed in liquid form, whereas practically all honeys crystallize rapidly. Honey from acacia is the exception since it crystallizes on average after 12 months of storage at ambient temperature. This difference in the speed of crystallization is due to the composition of this honey which has a predominant fructose concentration relative to the other sugars and in particular relative to glucose.

The sugar (mainly glucose) concentration therefore influences the speed of crystallization of honey. A coefficient makes it possible to know the tendency for honey to crystallize. This coefficient is the ratio between the fructose concentration and the glucose concentration (F/G). If this ratio is close to 1, the speed of crystallization will be high (for example: honey from rape). If this ratio is between 1.4 and 1.8, the honey will remain liquid and transparent for a minimum of 12 months at ambient temperature (like honey from acacia).

Another parameter is used to predict the speed of crystallization of honey: it is the ratio between the glucose concentration and the quantity of water in honey (D/W). When this ratio is less than 2.2, the honey remains liquid for a long period.

The inventors have moreover identified a third parameter which makes it possible to predict they speed of crystallization of honey since they have observed that honey containing less than 30% glucose (by mass) will also have a tendency to remain liquid and transparent for several months.

The inventors have observed that, depending on the cases, measuring just one of the parameters mentioned above is sufficient to know exactly the propensity of honey to crystallize, whereas, in other cases, it is necessary to combine two or even three of them. For example, when the method is always carried out with the same honey, persons skilled in the art will be able to determine whether, for this particular honey, it is sufficient to have an F/G ratio greater than a given value (experimentally determined) in order to be sure that it will remain clear during several months of storage. Thus, the inventors have observed that, for honey from sunflower, an F/G value>1.4 makes it possible to ensure a storage of one year without crystallization. For a ratio between 1.1 and 1.4, this same honey will remain clear for a shorter period, and the period before it crystallizes will vary according to other parameters (D/W and the total percentage of glucose). For more complex honeys, for example for honeydews containing more dietary fiber, it may be necessary, at least in a first instance, to check the three parameters in order to ensure good preservation of the honey in clear form after treatment according to the invention.

Currently, two techniques are used to make honey more liquid:
The first is to heat the honey in order to give it a liquid appearance. This liquefaction is obtained by dissolving the glucose crystals. This method does not avoid secondary recrystallization. The increase in temperature also induces denaturation by a premature aging of the product. This aging can be quantified by measuring the concentration of Hydroxymethylfurfural (HMF). HMF is a product of degradation of sugars. The maximum limit authorized in honey is 40 mg/kg.
The second technique is stirring honey in various ways (cf. patent FR 732 192 B1). This stirring mechanically breaks the crystals formed in order to obtain a paste that is more easily malleable, but the transparent appearance is not obtained.

Other techniques for the liquefaction of honey have been described. They are mainly based on the two techniques previously described.

Patent GB 2 435 391 A presents a complex technique in several stages. The honey is first heated to 90° C. in order to make it liquid and to pasteurize it. Next, the honey is filtered at 5 μm in order to remove all the solid particles (for example: pollen grains) which may be involved in the secondary crystallization. This technique doubly denatures the honey: on the one hand by heating the product which induces deterioration of the enzymes and on the other hand by microfiltration which eliminates the pollen map of the honey.

The principle of patent JP 2607604 is to filter (at 0.1-0.3 μm) hot honey 50° C.) in order to obtain a liquid honey without cloudiness, but partially preserving the sugar content and the flavors.

All these techniques have the disadvantage of only being temporary (the honey will rapidly recrystallize) and degrading from a quality point of view. Indeed, excessive heating of honey (50° C. or more, for a significant period, typically greater than one hour) unavoidably induces degradation of the enzymes and the vitamins initially present, as well as degradation of the sugars with production of HMF.

Two parameters are generally used to measure the quality of honey. They are the HMF level and the diastase number. “Fresh” honey, which has just been harvested, contains on average 3 mg/kg of HMF. In the absence of heat treatment, the HMF level increases slowly and in a variable manner depending on the honey. Acidic honeys naturally produce more HMF than the others, and take about 10 mg/kg per year at 20° C., whereas in the honeydew honeys, for example, the HMF level will practically not change. Regardless of the type of honey, a heat treatment will greatly increase the HMF level. The diastase number makes it possible to measure the enzymatic quality of honey. It is expressed as “Schade” units. In the absence of excessive heating, it should be greater than 8.

A real need currently exists for a method which makes it possible, on the one hand, to preserve honey in clear liquid form for a period of at least several months, preferably at least one year, and, on the other hand, not to degrade the quality of the product.

The present invention satisfies this need since it relates to a method which confers on any honey the properties of being clear and liquid which are required to satisfy consumers, without requiring excessive heating of the product. Its principle consists in starting with a honey containing glucose crystals (honey undergoing crystallization or that is completely crystallized), and extracting glucose crystals therefrom, in order to obtain, for at least one of the three parameters mentioned above (F/G, D/W or glucose level), a value compatible with good preservation of the honey in liquid and transparent form.

The present invention therefore relates firstly to a method for treating honey which is at least partially crystallized, comprising a step of removing at least part of the glucose crystals contained in said honey, such that, at the end of this step, the ratio between the fructose and glucose concentrations in said honey is greater than 1.1 (F/G>1.1), and/or the ratio between the glucose concentration and the quantity of water in said honey is less than 2.2 (D/W<2.2), and/or the proportion by mass of glucose in said honey is less than 30%. In addition, the percentage of water in the honey obtained should remain less than or equal to 21%, preferably less than or equal to 20%, in order to ensure good preservation of the product.

As mentioned above, honey for which at least one of these three parameters is in the required range can be stored for several months at ambient temperature in liquid and transparent form without crystallizing. Persons skilled in the art will therefore choose, according to the tools at their disposal, the parameter which they will judge to be the easiest to measure.

According to a particular embodiment of the method of the invention, at the end of the step of removing the glucose crystals, the F/G ratio is greater than or equal to 1.4. Preferably, part of the glucose will be preserved, such that the F/G ratio remains less than or equal to 5.

Alternatively or additionally, the method is carried out in order to obtain, at the end of the step of removing the glucose crystals, a D/W ratio of less than 1.8.

Alternatively or additionally, the method is carried out in order to obtain, at the end of the step of removing the glucose crystals, a proportion by mass of glucose of less than or equal to 28%, which will however remain, in a preferred embodiment of the method, greater than or equal to 10%.

According to specific embodiment of the method according to the invention, the crystals removed from the honey have a mean diameter between 1 and 100 μm.

The method of the invention may be carried out using, in order to separate the glucose crystals to be removed from the remainder of the honey, an acceleration. According to this embodiment, the method may comprise the steps below:
(i) centrifugation of the honey, under the following conditions:
   temperature between 10 and 60, or even 70° C., preferably<50° C., preferably still 45° C.
   centrifugal force between 1000 and 30 000 g
   duration of centrifugation between a few tenths of a second and 5 hours, preferably less than 2 hours; and
(ii) recovery of the top phase.

Persons skilled in the art will adapt the combination of the three parameters (temperature, duration of centrifugation and centrifugal force) according to the honey to be treated, in order to obtain a clear liquid top phase containing at most 21% water. Indeed, a centrifugation that is too strong is likely to lead to dehydration of the solution of glucose crystals, and therefore to a proportion of water that is too high (>21%) in the clear fraction. FIG. 4 presents an example of a surface area of response, presenting on the y-axis the percentage transparency of the top phase, as a function of the pair (centrifugation time) for a given honey (honey from sunflower) and at a given temperature (35° C.). Persons skilled in the art are capable of obtaining, by routine experiments, an equivalent graph for any type of honey and any temperature, or by setting another parameter (centrifugation time or force) and by varying the temperature, and the like, and deducing therefrom conditions suitable for the honey which they have to treat and for the constraints (desired result, material used, and the like).

Of course, the bottom phase, containing the extracted glucose crystals, may also be recovered. As described in the experimental part, this phase constitutes a honey that is particularly high in glucose, which will rapidly crystallize. This phase contains the same pollen map as the clear top phase.

According to a particular embodiment of the invention, illustrated in the experimental part, the centrifugation is performed between 30 and 40° C., at 6000 to 14 000 g, preferably between 7000 and 11 000 g, for 45 to 60 minutes.

According to an alternative embodiment, the step of removing the glucose crystals is carried out by ultrafiltration. This may be carried out, for example, under the following conditions:
temperature of the honey between 30 and 48° C., preferably 45° C.
pressure between 3 and 10 bar
cut-off of the filter: between 0.7 and 1.5 μm.

It is important to note that the temperature should be carefully determined, depending on the full installation used (continuous or batch mode, speed of filtration, and the like), in order to avoid the honey remaining at a high temperature for an excessively long time so as to avoid degradation of the enzymes and of the vitamins contained in the starting material, and an increase in the HMF level. Furthermore, since the aim of the filtration is to retain the glucose crystals, it is necessary to avoid excessive heating from resulting in the dissolution of these crystals. In practice, keeping the honey at a temperature greater than or equal to 45° C. for more than one hour, preferably for no more than 30 minutes, should be avoided.

According to this embodiment of the invention, the cut-off of the filter is preferably of the order of 1 μm. Unlike the embodiment described above, where the glucose crystals are extracted by centrifugation, the liquid honey obtained by filtration will be at least partially depleted of pollen. However, its vitamin and enzyme content will remain unchanged. Quite obviously, the retentate, which constitutes honey that is high in glucose but also enriched with pollen, is advantageously recovered.

Because of the high viscosity of honey that is at least partially crystallized, the step of removing the glucose crystals will be advantageously preceded by a step of stirring the honey, combined or otherwise with a heating step. Indeed, it is necessary, in particular in cases where the honey is completely set, to make it more fluid. Mechanical stirring makes it possible to make the honey capable of being pumped, while limiting the heating.

Where appropriate, if the honey is initially sufficiently fluid, the step of removing the glucose crystals may be preceded by a step of heating the honey without mechanical stirring. In all cases, the heating, whether combined or otherwise with mechanical stirring, should remain moderate, that is to say at a temperature between 30 and 60° C., preferably<50° C., and such that the honey does not remain at a temperature 45° C. for more than one hour, preferably for no more than 30 minutes, during the entire method.

In a particular embodiment, the temperature of the honey will not exceed 45° C., or even 40° C., during the entire treatment method (pumping and removal of the glucose crystals).

The present invention also relates to honey that is capable of being obtained by a method as described above. Such a honey has the following characteristics:
low HMF level 10 mg/kg during packaging),
high diastase number (>8),
F/G ratio >1.1 (preferably between 1.4 and 5),
D/W ratio <2.2,
percentage (by mass) of glucose<30%, preferably≦28%, while preferably remaining≧10%,
percentage of water≦21%, preferably≦20%,
transparency and stability: the honey should be clear and remain clear for several months, preferably at least 1 year, under standard storage conditions (20° C., darkness),
pollen, physicochemical (except glucose level) and sensory properties characteristic of honey which, in the absence of treatment, would crystallize in less than one year of storage under standard conditions. Persons skilled in the art may indeed, by an analysis of the pollen map (determined by melissopalynology), supplemented with physicochemical information (color, electrical conductivity, acidity, and the like) and sensory information, determine—at least approximately—the origin of a honey. For example, a honey according to the invention may have, apart from the glucose level which will be lower than the natural level (and therefore modified F/G and D/W ratios), the characteristics of a honey from sunflower, rape, lavender, eucalyptus, sainfoin, rhododendron, lime, heather, chestnut, thistle, alfalfa, dandelion, rosemary, thyme, clover, arbutus, hawthorn, ivy, raspberry, wild thyme, lemon, orange and/or holly, and the like. In particular, the pollens may correspond to those which would be found in a so-called “all flowers” honey predominantly containing pollens of one or more species mentioned above. The honeydew honeys according to the invention will also have a glucose level lower than the glucose level naturally present in honeydew honeys (between 23.5 and 26.5%), which will allow their preservation in clear form for a year.

The present invention will be understood more clearly with the aid of the additional description which follows, which presents in greater detail an example of treatment of a crystallized honey by centrifugation in order to extract the glucose crystals therefrom.

### LEGEND TO THE FIGURES

FIG. 1: Diagram of the treatment method (centrifugation version)

FIG. 2: On the left, the heavy phase (absorbance not measurable, F/G=1.1 and D/W=2.1) and, on the right, the light phase (absorbance=0.107, F/G=1.6 and D/W=0.3).

FIG. 3: Two-phase centrifuged sunflower honey (operating conditions: 35° C., 11 000 g, 55 min).

FIG. 4: Variation of the transparency (%) as a function of the time (min)/RCF (g) pair. The transparency is defined relative to the maximum transparency value obtained experimentally (=100%). The transparency is obtained by measuring the absorbance in a spectrometer at 600 nm.

### EXAMPLES

### Example 1

### Method of Extracting Glucose Crystals by Centrifugation

Principle:

The principle applies to the reduction in the quantity of glucose present in honey (a sugar which is most often predominant), in order to obtain for any type of honey a Fructose/Glucose ratio between 1.1 and 1.7 and/or a glucose/water (D/W) ratio of less than 2.2.

Method:

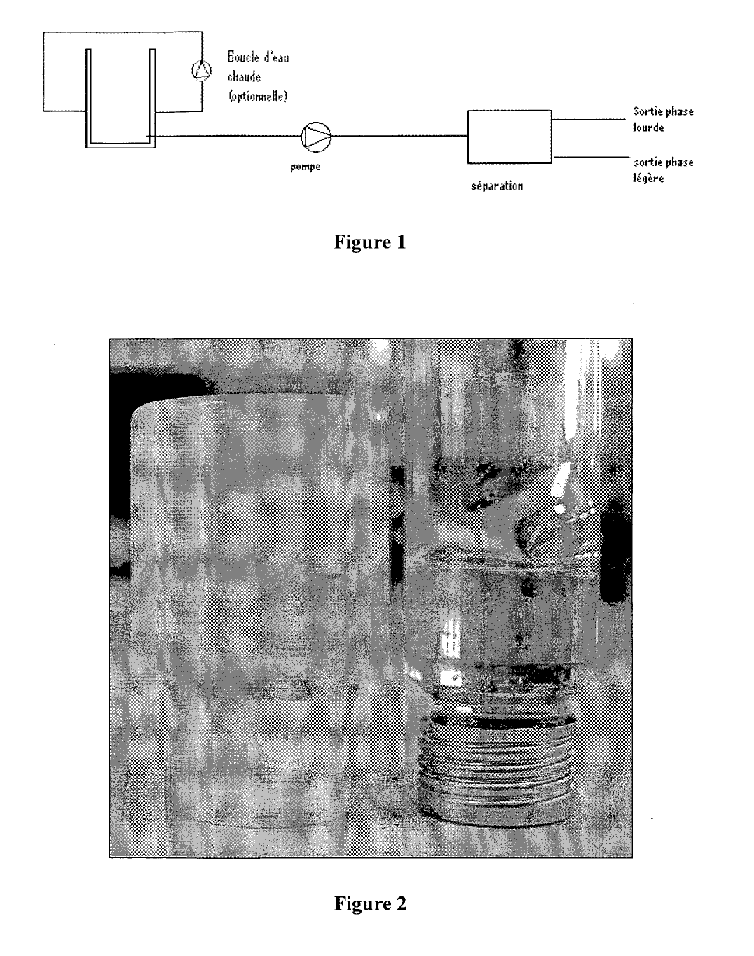

Once crystallized, the honey is desolidified by a mechanical and/or thermal technique and then centrifuged. The method is schematically represented in FIG. 1.

The centrifugation makes it possible to obtain two phases:
The less dense phase (representing 40 to 70% by volume), called “light” phase, is predominantly composed of soluble fructose and glucose (1.4<F/G<1.6; and/or D/W<2.2). This phase then has an appearance close to an acacia honey and will be liquid and transparent for a minimum period of several months.
The more dense phase (60 to 30% by volume), called “heavy” phase, is predominantly composed of glucose crystals. This phase is creamy and non-translucent, and will crystallize.

During the centrifugation, many operating parameters play a role in the separation of the sugar crystals. The main factors are:
the nature of the honey,
the temperature of the honey (10° C. to 80° C.),
the centrifugal force (from 1000 to 30 000 g) and
the residence time (from a few tenths of a second to 2 hours).

### DETAILED DESCRIPTION OF THE METHOD

The crystallized honey is heated or stirred sufficiently so as to be able to pump it. If the honey is heated, it is important not to have a product time*temperature that is too high because the HMF level would increase to a value that is too high and the honey would be denatured (decrease in the quality of the honey). It is between 30 and 60° C. that the product is most easily pumpable, without having as a result a high HMF level in the finished product. It is also possible to recover the honey by stirring, which reduces the required temperature and therefore avoids denaturation of the product.

The honey then enters the centrifuge in order to obtain 2 phases at the outlet: a light phase and a heavy phase. The proportions of the two phases are between 40/70% and 60/30% by volume, respectively.

The light phase is mainly composed of soluble sugars and water (1.4≦F/G≦1.8 and D/W<2.2). It is important to specify that the other elements characteristic of the origin of the honey (pollen, enzymes, wax) are well preserved in each of the phases.

It is extremely important to properly control the values of the residence time and centrifugal force exerted on the honey. The centrifugal force is expressed as RCF (Relative Centrifuge Force) or in g. For example, for a honey at 35° C., it is necessary to have a minimum of 7000 g and a minimum residence time of 55 minutes in order to obtain the expected result (transparent and liquid light phase).

It is important to properly control the speed of centrifugation because a centrifugal force that is too high could dehydrate the solution of glucose crystals (heavy phase). The consequence could be a quantity of water in the light phase greater than the legal limit (21% for the majority of honeys) and the development of microorganisms.

### Example 2

### Separation of Glucose Crystals from a Sunflower Honey in the Laboratory

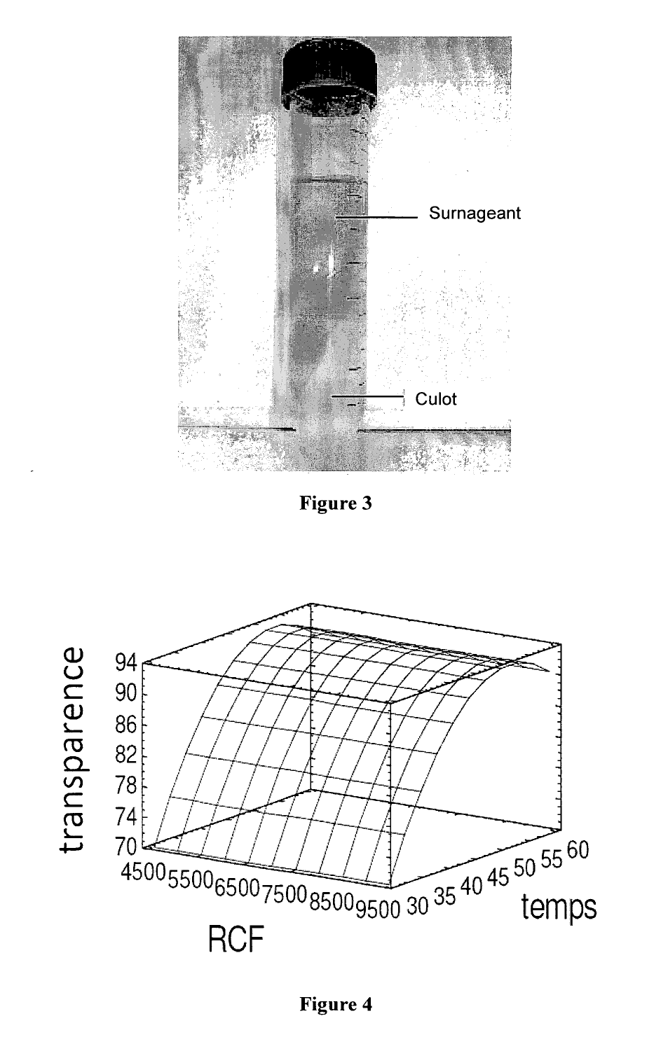

The experiment applies to a crystallized sunflower honey of less than one year (complete crystallization). The honey is homogenized by stirring before use. This honey is pasty and opaque. The product is thermostated beforehand at 35° C. on a water bath for 15 minutes and checked by a thermometer. Once the honey reaches the temperature, it is introduced into a laboratory centrifuge (SIGMA laborzentrifugen 3K15). Thirty grams of product are introduced per tube. After 55 minutes at 11 000 g in the centrifuge thermostated at 35° C., the honey is separated into two phases (FIG. 3).

The light phase is transparent. This transparency is measured by a spectrophotometer at a wavelength of 600 nm. The absorbance is 0.102.

The F/G and D/W parameters are, respectively, for the light phase: 1.6 and 0.6 and, for the heavy phase: 1 and 2.2.

The graph of FIG. 4 shows the variation in the transparency of the light phase (obtained by measuring the absorbance at 600 nm), as a function of the pair (centrifugation time/RCF), at 35° C.

1. A method for treating honey which is at least partially crystallized, comprising a step of removing at least part of the glucose crystals contained in said honey, such that, at the end of this step, the honey contains at most 21% water, the ratio between the fructose and glucose concentrations is greater than 1.1 (F/G>1.1), and/or the ratio between the glucose concentration and the quantity of water is less than 2.2 (D/W<2.2), and/or the proportion by mass of glucose is less than 30%.

2. The method as claimed in claim 1, wherein, at the end of the step of removing the glucose crystals, F/G≧1.4.

3. The method as claimed in claim 1, wherein, at the end of the step of removing the glucose crystals, 1.1<F/G≦5.

4. The method as claimed in claim 1, wherein, at the end of the step of removing the glucose crystals, D/W<1.8.

5. The method as claimed in claim 1, wherein, at the end of the step of removing the glucose crystals, the proportion by mass of glucose is less than or equal to 28%.

6. The method as claimed in claim 1, wherein, at the end of the step of removing the glucose crystals, the proportion by mass of glucose in the honey is greater than or equal to 10%.

7. The method as claimed in claim 1, wherein the crystals removed from the honey have a mean diameter between 1 and 100 μm.

8. The method as claimed in claim 1, wherein the removal of the glucose crystals is carried out using an acceleration.

9. The method as claimed in claim 1, comprising the following steps:
(i) centrifugation of the honey, under the following conditions:
temperature between 10 and 60° C.
centrifugal force between 1000 and 30,000 g
duration of centrifugation between a few tenths of a second and 5 hours;
(ii) recovery of the top phase.

10. The method as claimed in claim 9, wherein the temperature of the honey is <50° C.

11. The method as claimed in claim 10, wherein the centrifugation is performed at a temperature of between 30 and 40° C., at an acceleration between 6000 and 14 000 g, for 45 to 60 minutes.

12. The method as claimed in claim 1, wherein the step of removing the glucose crystals is carried out by ultrafiltration, under the following conditions:
temperature of the honey between 30 and 48° C.,
pressure between 3 and 10 bar, and
cut-off of the filter between 0.7 and 1.5 μm.

13. The method as claimed in claim 12, characterized in that the cut-off of the filter is 1 mm.

14. The method as claimed in claim 1, wherein the step of removing the glucose crystals is preceded by a step of mechanically stirring the honey.

15. The method as claimed in claim 1, wherein the step of removing the glucose crystals is preceded by a step of heating the honey to a temperature between 30 and 60° C.

16. The method as claimed in claim 1, wherein the temperature of the honey remains 40° C.

17. A honey obtained by the method as claimed in claim 1.

18. The method of claim 12, wherein the temperature of the honey is between 30 and 45° C.

19. The method as claimed in claim 15, wherein the honey is heated to a temperature between 30 and 50° C.
